(19) United States
(12) Patent Application Publication
(10) Pub. No.: US 2021/0241145 A1
(43) Pub. Date: Aug. 5, 2021

(54) GENERATING ROLES IN SPORTS THROUGH UNSUPERVISED LEARNING

(71) Applicant: STATS LLC, Chicago, IL (US)

(72) Inventors: Paul David Power, Leeds (GB); William Thomas Gurpinar-Morgan, Worcester (GB); Daniel Richard Dinsdale, London (GB); Joe Dominic Gallagher, Wirral (GB); Nils Sebastiaan Mackaij, Amsterdam (NL)

(73) Assignee: STATS LLC, Chicago, IL (US)

(21) Appl. No.: 17/167,400

(22) Filed: Feb. 4, 2021

Related U.S. Application Data
(60) Provisional application No. 62/970,234, filed on Feb. 5, 2020.

(51) Int. Cl. G06N 5/04; G06N 20/00

(52) U.S. Cl. CPC G06N 5/04; G06N 20/00

(57) ABSTRACT

A system and method for generating a role summary associated with one or more players are disclosed herein. A computing system retrieves event information for a plurality of teams for a plurality of events. The computing system generates a spatial output that describes each player. The computing system identifies a playing style associated with each team. The computing system identifies a subset of paths a player or team takes between two zones. The computing system identifies each player's involvement in a team's process. The computing system generates a score corresponding to a value of a player's involvement in a given play based on the event information. The computing system generates a score associated with each player's passing ability based on the event information. The computing system determines a shot style of each player based on the event information. The computing system identifies a role associated with each player.

### CROSS-REFERENCE TO RELATED APPLICATIONS

This application claims priority to U.S. Provisional Application Ser. No. 62/970,234, filed Feb. 5, 2020, which is hereby incorporated by reference in its entirety.

### FIELD OF THE DISCLOSURE

The present disclosure generally relates to system and method for generating data driven roles in sports through unsupervised learning.

### BACKGROUND

When evaluating a player on your team or evaluating a player to be added to your team, scouts typically rely on position labels to identify those players that fit a certain set of criteria. However, as sports evolve so to do the characteristics associated with traditional or classical definitions of a position. For example, in basketball, the 2000s have seen teams shift away from the classical definition of the center position to a modern definition of the center position, which now requires a greater shooting range and greater range of mobility than ever before.

### SUMMARY

In some embodiments, a method for generating a role summary associated with one or more players. A computing system retrieves event information for a plurality of teams for a plurality of events. The event information includes information associated with a movement of a ball during each event. The computing system generates a spatial output that describes each player of the one or more players based on the event information. The computing system identifies a playing style associated with each team of the plurality of teams based on the event information. The computing system identifies a subset of paths a player or team takes between two zones on a field based on the event information. The computing system identifies each player's involvement in a team's process based on the event information and the subset of paths the player or team takes between the two zones on the field. The computing system generates a value corresponding to a player's involvement in a given play based on the event information. The computing system generates a score associated with each player's passing ability based on the event information. The computing system determines a shot style of each player based on the event information. The computing system identifies a role associated with each player based on the spatial output, the playing style, the subset of paths, each player's involvement in their team's process, the value corresponding to the value associated with a player's involvement in a given play, the score associated with each player's passing ability, and the shot style of each player.

In some embodiments, a non-transitory computer readable medium is disclosed herein. The non-transitory computer readable medium includes one or more sequences of instructions, which, when executed by one or more processors, causes a computing system to perform operations. The operations include retrieving, by the computing system, event information for a plurality of teams for a plurality of events. The event information includes information associated with a movement of a ball during each event. The operations further include generating, by the computing system, a spatial output that describes each player of the one or more players based on the event information. The operations further include identifying, by the computing system, a playing style associated with each team of the plurality of teams based on the event information. The operations further include identifying, by the computing system, a subset of paths a player or team takes between two zones on a field based on the event information. The operations further include identifying, by the computing system, each player's involvement in a team's process based on the event information and the subset of paths the player or team takes between the two zones on the field. The operations further include generating, by the computing system, a score corresponding to a value of a player's involvement in a given play based on the event information. The operations further include generating, by the computing system, a score associated with each player's passing ability based on the event information. The operations further include determining, by the computing system, a shot style of each player based on the event information. The operations further include identifying a role associated with each player based on the spatial output, the playing style, the subset of paths, each player's involvement in their team's process, the score corresponding to the value of a player's involvement in a given play, the score associated with each player's passing ability, and the shot style of each player.

In some embodiments, a system is disclosed herein. The system includes one or more processors; and a memory. The memory has programming instructions stored thereon, which, when executed by the one or more processors, causes the system to perform operations. The operations include retrieving event information for a plurality of teams for a plurality of events. The event information includes information associated with a movement of a ball during each event. The operations further include generating a spatial output that describes each player of the one or more players based on the event information. The operations further include identifying a playing style associated with each team of the plurality of teams based on the event information. The operations further include identifying a subset of paths a player or team takes between two zones on a field based on the event information. The operations further include identifying each player's involvement in a team's process based on the event information and the subset of paths the player or team takes between the two zones on the field. The operations further include generating a score corresponding to a value of a player's involvement in a given play based on the event information. The operations further include generating a score associated with each player's passing ability based on the event information. The operations further include determining a shot style of each player based on the event information. The operations further include identifying a role associated with each player based on the spatial output, the playing style, the subset of paths, each player's involvement in their team's process, the score corresponding to the value of a player's involvement in a given play, the score associated with each player's passing ability, and the shot style of each player.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating role prediction platform, according to example embodiments.

FIG. 3 illustrates exemplary pass origin and pass destination heatmaps, according to example embodiments.

FIG. 4 illustrates a principle component analysis (PCA) plot, according to example embodiments.

FIG. 5 is a block diagram illustrating a playing style chart, according to example embodiments.

FIG. 6A is a block diagram illustrating a pass start zone template, according to example embodiments.

FIG. 6B is a block diagram illustrating a pass end zone template, according to example embodiments.

FIG. 7 illustrates a chart that illustrates the possession value (PV+) of various players on a team, according to example embodiments.

FIG. 8A is a chart illustrating a pass risk reward profile, according to example embodiments.

FIG. 8B is a chart illustrating expected pass completion rate, according to example embodiments.

FIG. 9 is a scatter plot illustrating groupings of players, according to example embodiments.

FIG. 10 is a flow diagram illustrating a method of generating a role summary for a player, according to example embodiments.

FIG. 11A is a block diagram illustrating a computing device, according to example embodiments.

FIG. 11B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

As sports evolve, the way teams evaluate players and their teams' needs also evolve. For example, take the sport of soccer. A full back classically defines a player to be a defender in the wide zones of the pitch or field. Over the years, however, the game of soccer has evolved—full backs are now more valued for their abilities to attack and create goals, more so than their abilities to defend and win possessions. Although this may be a positive development for the sport, this creates an issue for recruitment departments who are trying to find both under-valued players and players that meet a certain set of criteria. Although the label “full back” may help reduce the number of players to scout, due to the ever-evolving definition of the position, players labeled full back in the classical sense could be mis-labeled by today's standards. In other words, the label may fail to describe the current roles that the player carries out.

The one or more techniques described herein leverage an ensemble of machine learning models to measure different aspects of team and player functions within a team. The process, for example, may aid in dynamically learning the “role” of a player, instead of relying on classical definitions of various roles. For example, the one or more techniques described herein allows teams to break down a player into three core elements: (a) quality measured by expected passes and possession value; (b) their spatial occupancy; and (c) their involvement in a process by moving away from aggregate counts to sequential modeling. Still further, the one or more techniques described herein may use a machine learning model to learn distributions of roles a player falls into. The system may use these features to not only describe a player, but the team as well. This allows a team or club to quickly identify players with features they most value, understand a role's value to a team, and identify those teams that play a similar style to recruit from.

Although the below discussion is directed to the sport of soccer, those skilled in the art recognize that the operations and techniques may be applied to other sports as well (e.g., baseball, basketball, football, hockey, rugby, etc.).

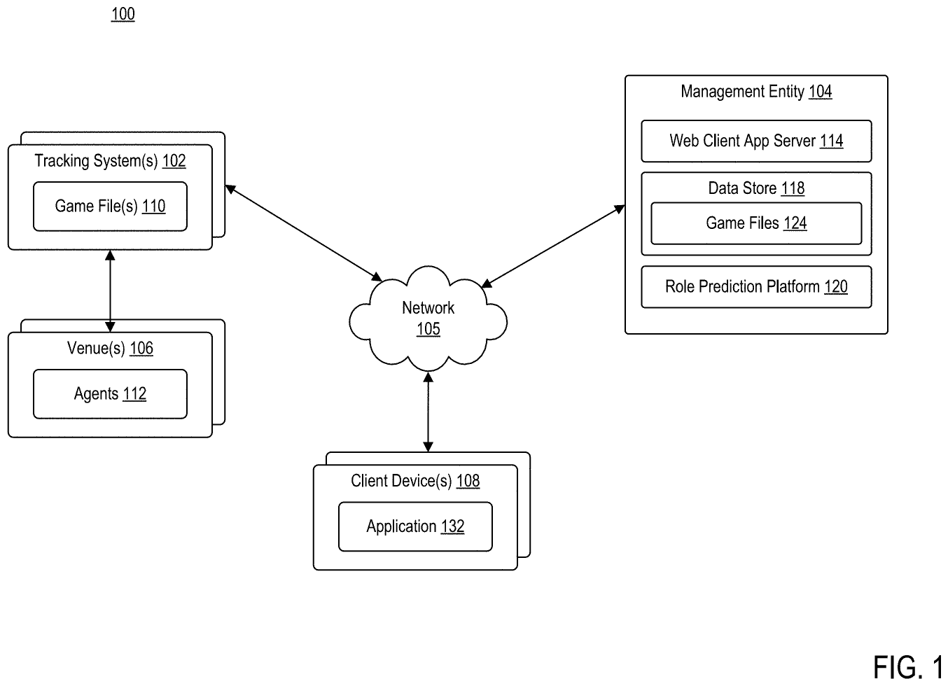

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to capture the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In another example, a mix of stationary and non-stationary cameras may be used to capture motions of all agents on the playing surface as well as one or more objects or relevance. As those skilled in the art recognize, utilization of such tracking system (e.g., tracking system 102) may result in many different camera views of the court (e.g., high sideline view, free-throw line view, huddle view, face-off view, end zone view, etc.). In some embodiments, tracking system 102 may be used for a broadcast feed of a given match.

Game file 110 may be representative of data associated with a particular match. For example, game file 110 may include information such as the capture motions of all agents and the ball (or puck), as well as one or more other objects of relevance. In some embodiments, game file 110 may further include event-level type information (hereinafter “event data”). For example, event data may be defined as actions a player performs when in possession of a ball. For example, a pass, shot, tackle, etc. In some embodiments, event data may capture information such as, but not limited to, x-,y-,z-coordinates of the ball, a player's name and identifier (e.g., player ID), a team's name and ID (e.g., team ID), time stamp, and other metadata such as game identifier (e.g., game ID), match date when the ball was touched, etc. In some embodiments, game file 110 may further include game context information (current score, time remaining, etc.). The data used to power the below referenced models may include the XYZ positional data of the ball when a player is in possession, the team ID, player ID, event ID, time stamp, period ID, sub qualifiers describing more detailed events such as pass type, duel type, set play type, and the like. This data may represent raw features that are then fed into a data processing layer that creates a new set of feature such as sequences, heatmaps of event locations, groupings of event types in zones of a pitch, speed of ball movement, etc.

Tracking system 102 may be configured to communicate with organization computing system 104 via network 105. Organization computing system 104 may be configured to generate one or more metrics directed to a range of roles associated with a player. Organization computing system 104 may include at least a web client application server 114, a data store 118, and a role prediction platform 120.

Role prediction platform 120 may include one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 124. Each game file 124 may include at least the event data for a given match. In some embodiments, each game file 124 may further include video data (e.g., broadcast data) of a given match. For example, the video data may be representative of a plurality of video frames captured by tracking system 102. In another example, the video data may be representative of a plurality of video frames from a broadcast video feed of the respective match. In some embodiments, each game file 124 may further include tracking data associated with the event. Exemplary tracking data may include, for example, the x- and y-coordinates of each individual player on the field.

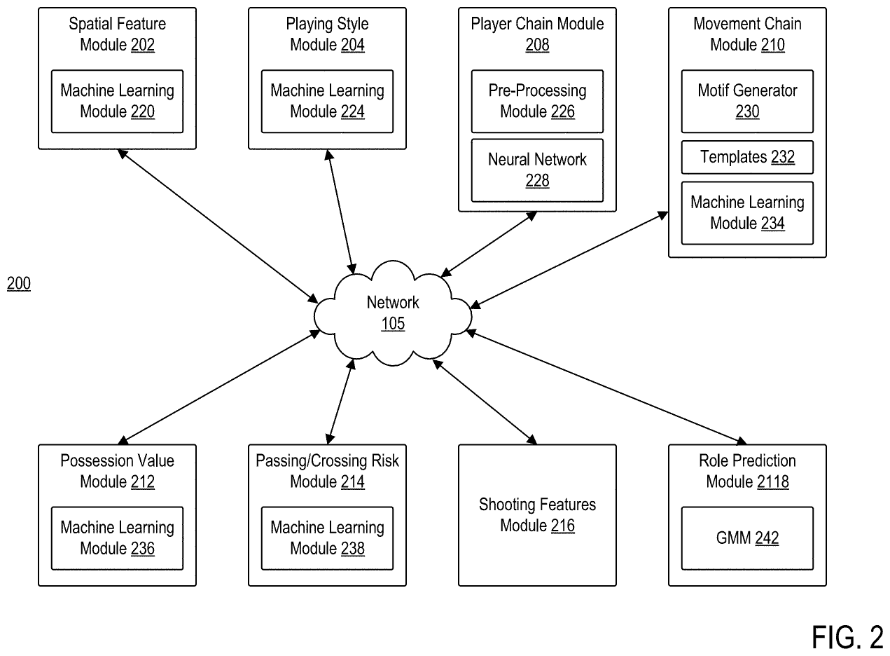

Role prediction platform 120 may be configured to predict various different aspects of team and player functions within a team. For example, role prediction platform 120 may utilize an ensemble of models that may work in conjunction to learn the role associated with a given player. In some embodiments, role prediction platform 120 may utilize event data to make such determination. The architecture associated with role prediction platform 120 is discussed in further detail below, in conjunction with FIG. 2.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 126. Application 126 may be representative of a web browser that allows access to a website or a stand-alone application. Client device 108 may access application 126 to access one or more functionalities of organization computing system 104. Client device 108 may communicate over network 105 to request a webpage, for example, from web client application server 114 of organization computing system 104. For example, client device 108 may be configured to execute application 126 to access content managed by web client application server 114. The content that is displayed to client device 108 may be transmitted from web client application server 114 to client device 108, and subsequently processed by application 126 for display through a graphical user interface (GUI) of client device 108.

FIG. 2 is a block diagram 200 illustrating role prediction platform 120, according to example embodiments. Role prediction platform 120 may include spatial feature module 202, playing style module 204, player chain module 208, movement chain module 210, possession value module 212, passing/crossing risk module 214, shooting features module 216, and role prediction module 218. Each of spatial feature module 202, playing style module 204, player chain module 208, movement chain module 210, possession value module 212, passing/crossing risk module 214, shooting features module 216, and role prediction module 218 may include one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Spatial feature module 202 may be configured to learn the importance of various locations on the field to a given player. For example, spatial feature module 202 may receive x-,y-coordinates of where a player makes a pass and where the pass goes. Given these x-,y-coordinates, spatial feature module 202 may generate a heat map that illustrates a pass origination and a pass destination for each pass initiated by a given player. Spatial feature module 202 may then pass the heat maps into machine learning module 220. In some embodiments, machine learning module 220 may include a non-negative matrix factorization (NMF) algorithm that is configured to learn a representation of different pitch (or field) zones as factors and assign weights to each factor, which may represent those pitch zones that are more or less important to a player. In some embodiments, machine learning module 220 may be trained to identify a set of “optimal” factors to create. For example, machine learning module 220 may implement an elbow method to determine the optimal amount of factors to identify from the heat maps. In some embodiments, Bayesian Information Criterion (BIC) may be used to determine the optimal numbers of clusters. BIC applies a number of Gaussian distributions across the data set. Spatial feature module 202 may then apply The Expectation Maximization (EM) algorithm to approximate the mean and variance of the distribution. To select the optimal number, the BIC score may increase until a penalty is applied for large numbers of clusters that increase complexity and starts to fit to noise. This point can be considered the elbow as the BUC score starts to decrease. Using a specific example, machine learning module 220 may be trained to identify 16 factors for pass origination and 16 factors for pass destination. Accordingly, spatial feature module 202 may be configured to output a total of different factors (pass start and pass destination) that describe the spatial distribution of a given player. Given, for example, spatial distributions for two players, a team can identify how similar two players are—irrespective of their position or role.

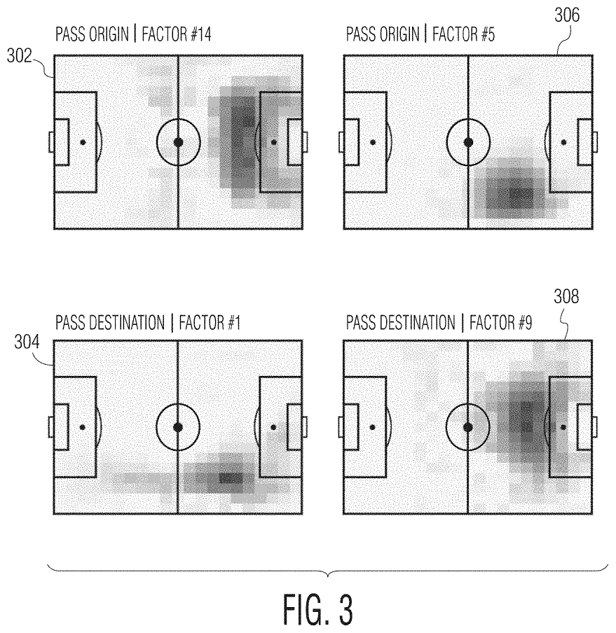

FIG. 3 illustrates exemplary heatmaps, according to example embodiments. As illustrated, FIG. 3 includes heatmaps 302-308. Heatmap 302 may illustrate a pass origin heatmap associated with a first factor. Heatmap 304 may illustrate a pass destination heatmap associated with a second factor. Heatmap 306 may illustrate a pass origin heatmap associated with a third factor. Heatmap 308 may illustrate a pass destination associated with a fourth factor.

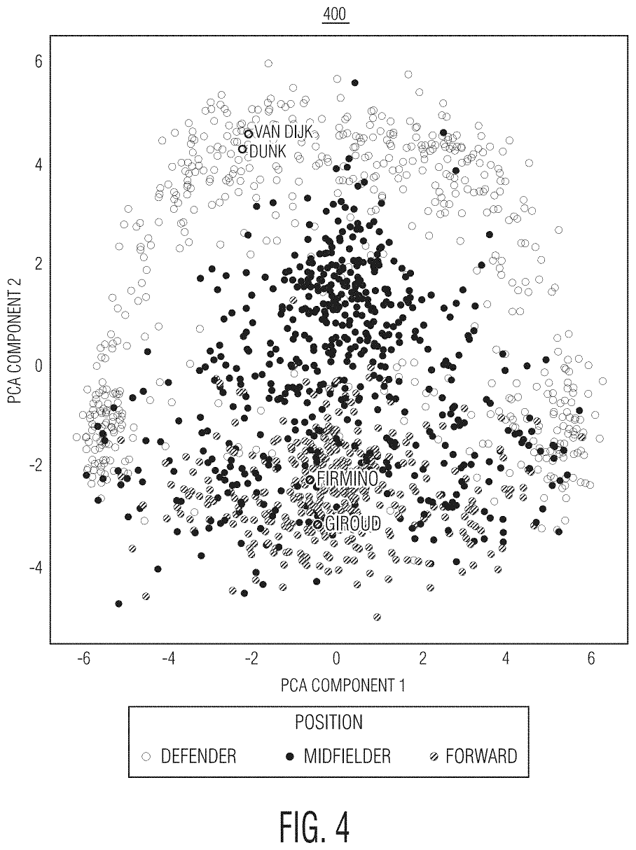

FIG. 4 illustrates a principle component analysis (PCA) plot 400, according to example embodiments. As provided above, spatial feature module 202 can aid in identifying how similar two players are based on their spatial distributions. As shown, PCA plot 400 illustrates that players Firmino and Giroud have similar spatial distributions based on, for example, their proximity in the PCA plot 400. Similarly, PCA plot 400 illustrates that players van Dijk and Dunk have similar spatial distributions based on, for example, their proximity in PCA plot 400.

Referring back to FIG. 2, playing style module 204 may be configured to identify a playing style associated with a specific team. Identifying the team's playing style may aid in providing context to a player's spatial distribution. To detect what style a team is playing at each touch of the ball, playing style module 204 may use a set of hand-crafted features to create membership values that describe the tactical context of a team's possession. For example, playing styles may be split into 8 types: maintenance (i.e., keeping possession in their own half), build up (i.e., keeping possession from the half way line to the opposition's half (e.g., oppositions 18 yard box)), sustained threat (i.e., keeping the ball in the attacking third of the field), fast tempo (i.e., moving the ball above a certain threshold pace (e.g., >4 m/s), counter attack (i.e., moving the ball forward quicker than a certain threshold (e.g., 7 m/s) after regaining possession), crossing (i.e., whether the team crosses the ball or not), direct play (i.e., a pass is made forward greater than a threshold distance (e.g., 20 meters)), and high pressing (i.e., winning possession in the attacking half quickly after losing possession).

To make such determination, machine learning module 224 may be trained to split event data of a game into one or more possessions. Each possession may include one or more touches. For each touch, machine learning module 224 may be trained to assign a value to that touch that represents one of the 8 categories of touches. Once all the touches are categorized, playing style module 204 may aggregate these values to generate a weighted count for each player. Playing style module 204 may then normalize these values based on a player's contribution to the team's total. As output, playing style module 204 may generate an 8 vector output.

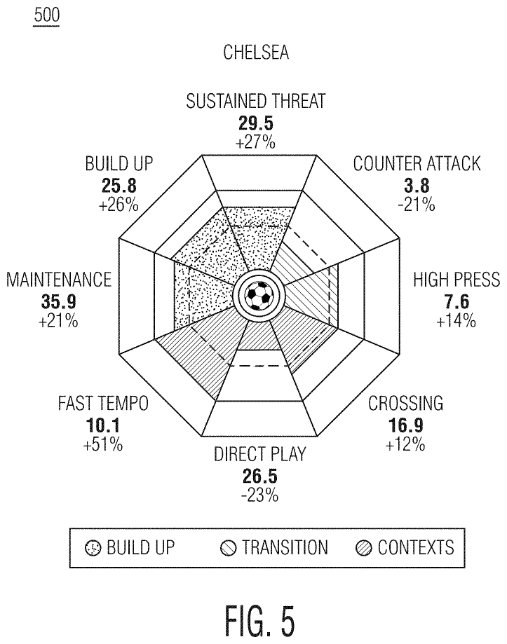

FIG. 5 is a block diagram illustrating a playing style chart 500, according to example embodiments. Playing style chart 500 may be generated, for example, based on the types of playing styles identified for a given team by playing style module 204. As illustrated, playing style chart 500 may be representative of playing styles associated with Chelsea. From the playing style chart 500, a team can see that a plurality of Chelsea's possessions are associated with a maintenance playing style and that Chelsea executes a counter attack playing style the least amount of times.

Referring back to FIG. 2, movement chain module 210 may be configured to identify the most common paths a player or team takes between two zones on the field. Movement chain module 210 may include motif generator 230, templates 232, and machine learning module 234. Motif generator 230 may be configured to generate one or more possession motifs that break down sequences of player combinations into chains of X-consecutive player possessions (e.g., four consecutive player possessions) from the same chain. For example, if four unique players are involved in a chain, motif generator 230 may classify this as ABCD, where each letter represents a player in the chain. By generating possession motifs, role prediction platform 120 may be able to find teams that use similar patterns of motifs. In some embodiments, role prediction platform 120 may utilize the possession motifs to identify those players that are involved in similar motifs.

Although possession motifs are useful in identifying teams that use similar patterns or motifs and players that are involved in similar motifs, possession motifs alone fail to take into account where on the pitch the motif occurred and the spatial semantics of how the motif was created. For example, a winger may be expected to have combination types such as ABAB or ABCB indicating give and goes and overlaps. However, a center back will also have a very similar profile, as this is often the passing combination seen when teams build out from the back.

To account for this limitation, templates 232 and machine learning module 234 are used to take into account the spatial component of the motif. Templates 232 may include a pass start zone template and a pass end zone template. Pass start zone template may be representative of a pitch divided into one or more zones, in which a pass is started or initiated. Pass end zone template may be representative of a pitch divided into one or more zones, in which a pass is destined or finished.

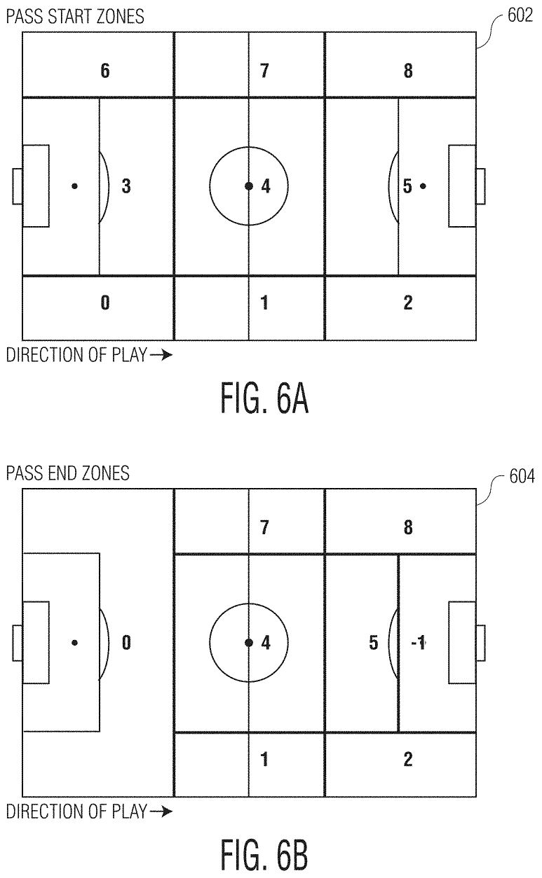

FIG. 6A is a block diagram illustrating a pass start zone template 602, according to example embodiments. FIG. 6B is a block diagram illustrating a pass end zone template 604, according to example embodiments. Pass start zone template 602 may be divided into a plurality of zones 0-8. Pass end zone template 604 may be divided into a plurality of zones −1, 0, 1, 2, 4, 5, 7, and 8. The direction of play is from left to right in each template 602, 604.

Referring back to FIG. 2, movement chain module 210 may provide context to the possession motifs generated by motif generator 230 using templates 232. For example, movement chain module 210 may supplement the possession motifs with zone information from templates 232. Thus, rather than merely knowing, for example, ABCD for a given possession, movement chain module 210 may label the passing start based on pass start zone template 602 and the passing end based on pass end zone template 604.

Machine learning module 234 may be configured to learn a spatial dictionary by taking all movement chains that start in one of the start zones and end in one of the end zones via k-means clustering. For example, movement chain module 210 may aggregate all chains that start in one zone (e.g., zone 1) and end in a second zone (e.g., zone 5) to generate a “super group” of possessions between zone 1 and zone 5. Machine learning module 234 may receive, as input, the super group of chains and identify the most common paths taken between the two zones using k-means clustering. In some embodiments, movement chain module 210 may use an elbow method to determine an optimal number of k.

Player chain module 208 may be configured to learn a player's involvement in a team's process. Player chain module 208 may include pre-processing module 226 and neural network 228. Pre-processing module 226 may be configured to create a context variable based on the labels and possession motifs created by movement chain module 210. For example, to create the context feature, pre-processing module 226 may concatenate the labels created from a possession motif, the super group of movement chains, and the most common paths taken within the super group (e.g., Start Zone 1, End Zone 8, ABCD, Cluster 1). Pre-processing module 226 may identify the player identifier (e.g., player ID) to create a target feature.

To learn the text “corpus,” pre-processing module 226 may identify the unique target and context labels and encode them as one hot representation. These one-hot representation features may now represent the inputs to neural network 228.

Neural network 228 may be representative of a 1-layer neural network configured to encode player identities based on their involvement in both the movement chains and the motifs. To train neural network 228, pre-processing module 226 may be configured to create true and false training patterns. For example, pre-processing module 226 may learn a weighting for popular targets and context pairs (True label) and find examples which either occurred very infrequently or not at all. These new pairs may be labeled a false. Neural network 228 may then receive, as input, the final true and false pairings for training. Neural network 228 may be trained, for example, using 400 epochs in batches of 64. The final embedding layer of 16 neurons by N players may then be extracted from a final feature vector to represent a player's involvement in a team's possession process. In some embodiments, neural network 228 may use the target variable (e.g., player name) to predict neighboring words known as contexts (e.g., tactical contexts). The final prediction layers of neural network 228 may provide a probability of the context word actually being one that is normally associated with the target player. In some embodiments, an embedding may be created to represent a player by taking the 16 neurons as output form the neural network 228.

Possession value module 212 may be configured to measure the “danger” of a player's involvement in a play. In other words, possession value module 212 may be configured to evaluate the player's value to a given play. Possession value module 212 may include machine learning module 236. Machine learning module 236 may be configured to learn how to predict the probability of a goal being scored based on, for example, events in a movement chain. In some embodiments, machine learning module 236 may receive, as input, a sequence of four events from the event data. For example, a sequence of events may include a pass from player one, a touch and dribble from player two, a pass from player two, and then a first time cross from player three. Based on this sequence of consecutive events, machine learning module 236 may predict the likelihood of a goal being scored. This information may allow a team to assess if a player is increasing or decreasing a team's chance of scoring. In some embodiments, machine learning module 236 may be representative of an xGBoost model.

To generate such prediction, machine learning module 236 may be trained using a sequence of x-events (e.g., four events). Machine learning module 236 may use, for example, the zones defined in pass start zone template and pass end zone template to bin player events and measure the average value they increase or decrease the chance of scoring by. This value may then be standardized as a percentile to represent the zones on the pitch a player creates the most danger. In some embodiments, the output from machine learning module 236 may be a per pass possession value number for each zone.

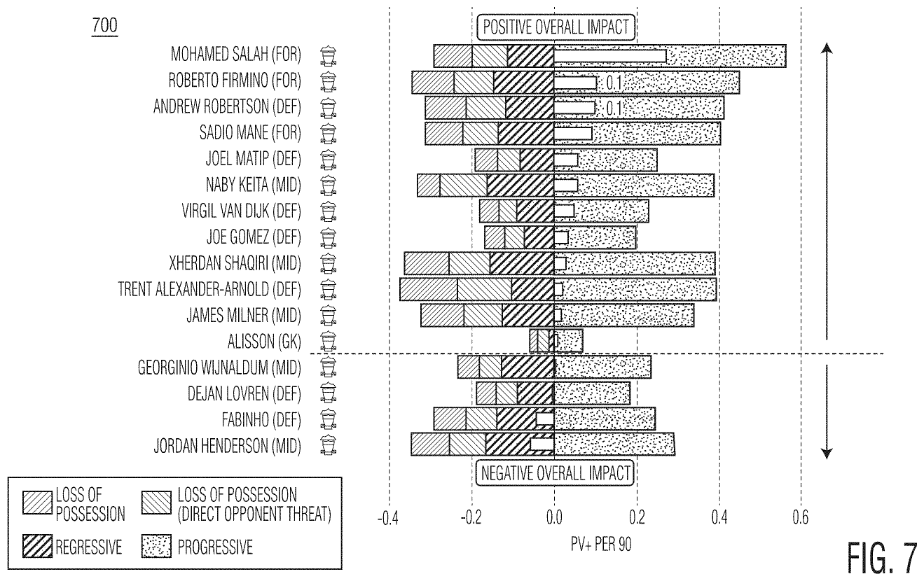

FIG. 7 illustrates a chart 700 that illustrates the possession value (PV+) of various players on a team, according to example embodiments. As illustrated, chart 700 may illustrate the PV+ of various players on Liverpool during the 2018 season. Chart 700 may be generated using the possession values generated by possession value module 212.

Passing/crossing risk module 214 may be configured to measure the skill of a player's passing ability. Passing/crossing risk module 214 may include machine learning module 238. Machine learning module 238 may be trained to predict the probability of a player completing a pass or a cross given its current context. In some embodiments, machine learning module 238 may receive, as input, a sequence of events. Machine learning module 238 may bin player events and measure the average risk of completing a pass. Machine learning module 238 may estimate the probability of completing a pass given this sequence of events. The output may be a probability between 0-1, with 1 being 100% chance of completing a pass. This value may be standardized as a percentile to represent the zones of the pitch a player creates the most danger or is of most value. In some embodiments, machine learning module 238 may be representative of an xGBoost model.

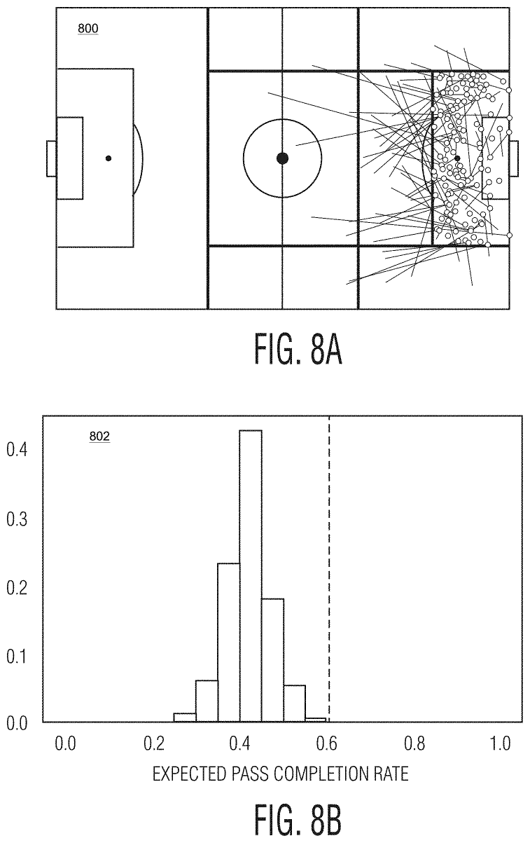

FIG. 8A is a chart 800 illustrating a pass risk reward profile, according to example embodiments. FIG. 8B is a chart 802 illustrating expected pass completion rate, according to example embodiments. As shown, given the passing/crossing risk values generated by passing/crossing risk module 214, a team may be able to visualize whether a given player is a good passer, safe passer, etc.

Referring back to FIG. 2, shooting features module 216 may be configured to determine a shot style of a player. For example, shooting features module 216 may be configured to split the pitch into one or more zones (e.g., 6 zones) and count how many shots a player has taken from each zone. Shooting features module 216 may then standardize these values based on the player's total shots taken. Shooting features module 216 may then concatenate the number of shots taken with the left and right foot and from their head. The output may be a standardized heatmap illustrating the percentage of shots that a player takes in each zone. In some embodiments, the count of shots may be standardized based on the total number of shots the player takes. Further, in some embodiments, shooting features module 216 may calculate the percentage of shots taken with the left foot, right foot, and head.

Role prediction module 218 may be configured to identify a role associated with various players. Role prediction module 218 may include a Gaussian mixture model (GMM) 242. GMM 242 may be configured to identify one or more roles that could be assigned to each player. To generate the prediction, GMM 242 may receive, as input, a vector of the features generated by each of spatial feature module 202, playing style module 204, player chain module 208, movement chain module 210, possession value module 212, passing/crossing risk module 214, and shooting features module 216 for one or more players. For example, the vector may include information directed to one or more of player ID, league ID, counter attack property, direct play property, fast tempo property, sustained threat property, high pressure property, build up property, maintenance property, possession value (PV) from each zone, expected pass (xP) completion rate from each zone, player embeddings, percentage of passes starting in each zone, percentage of passes ending in each zone, percentage of shots that a player takes in each zone, percentage of shots that a player takes with his or her right foot, percentage of shots that a player takes with his or her left foot, percentage of shots that a player takes with his or her head, etc. In some embodiments, this list may not be exhaustive and may include additional metrics generated above. Given this input, GMM 242 may be configured to generate one or more clusters of players. Each cluster may correspond to a unique player role.

In order to add meaning to the clusters, role prediction module 218 may use a data driven method of taking features that fall within the 75^{th} percentile. Role prediction module 218 may use these features to populate text templates to allow simple summaries of the primary roles for these players. For example, role prediction module 218 may generate:

| Description | Cluster | Size | Primary Positional Group | Main Features | Example Players |
|---|---|---|---|---|---|
| Attacking | 9 | 27 | Midfielders/Forwards | Ball progression from central | Firmino, |
| playmakers/ | | | | midfield and attacking zone & | Messi, De |
| instigators | | | | penalty area, through relatively | Bruyne, Pogba |
| | | | | easier passes. High shot | |
| | | | | contribution from outside and | |
| | | | | within penalty area. Heavily | |
| | | | | involved in attacking phase | |
| Pure forwards | 24 | 90 | Forwards | Foot shots in penalty area and | Lewandowski, |
| | | | | headers (less important than | Giroud, Piatek, |
| | | | | target-men cluster). Limited ball | Zapata |
| | | | | progression via passing. Carry | |
| | | | | ball with feet. No clear playing | |
| | | | | style involvement. Harder | |
| | | | | passes typically, except | |
| | | | | easier passes into penalty area | |

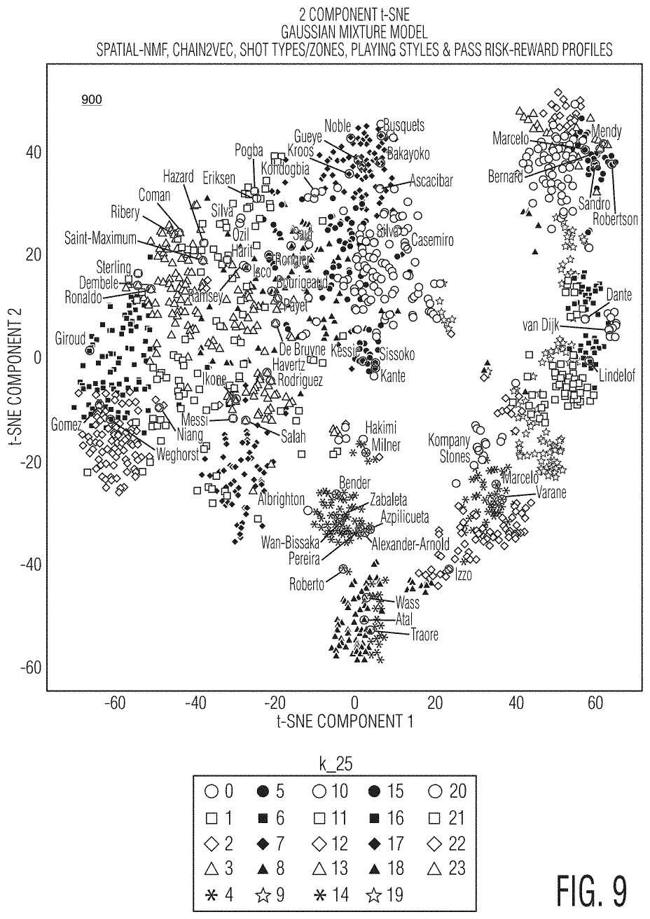

FIG. 9 is a scatter plot 900 illustrating groupings of players generated by GMM 242, according to example embodiments. As illustrated, GMM 242 may have grouped players into 25 unique clusters, with each cluster corresponding to a unique role.

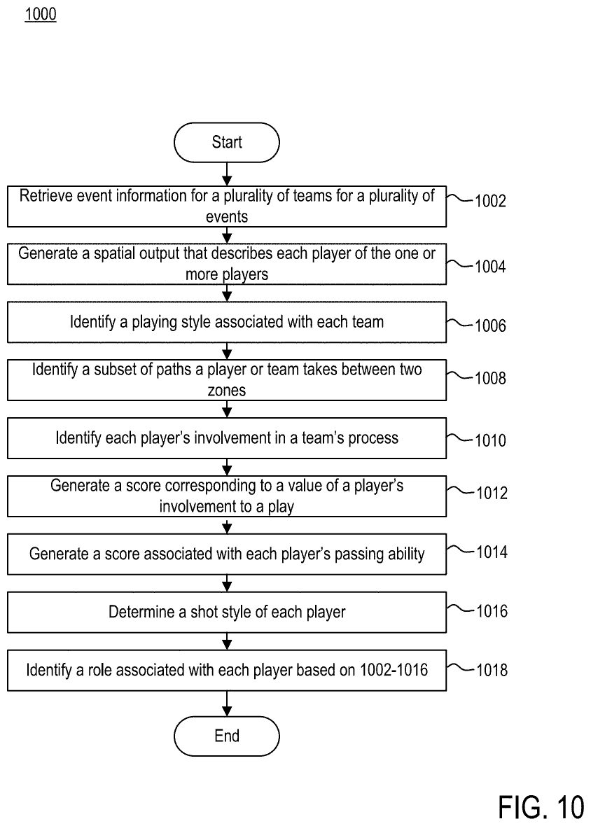

FIG. 10 is a flow diagram illustrating a method 1000 of generating a role summary for a player, according to example embodiments. Method 1000 may begin at step 1002.

At step 1002, organization computing system 104 may retrieve event information from data store 118.

At step 1004 organization computing system 104 may generate a spatial output that describes each player of the one or more players in the event information. For example, spatial feature module 202 may receive x-,y-coordinates of where a player makes a pass and where the pass goes. Given these x-,y-coordinates, spatial feature module 202 may generate a heat map that illustrates a pass origination and a pass destination for each pass initiated by a given player. Spatial feature module 202 may then pass the heat maps into machine learning module 220 to identify one or more factors (e.g., 16) for pass origination and one or more factors (e.g., 16) for pass destination for each player identified in the event information. Accordingly, spatial feature module 202 may be configured to output a total of different factors (pass start and pass destination) that describe the spatial distribution of a given player.

At step 1006, organization computing system 104 may identify a playing style associated with a specific team. Identifying the team's playing style may aid in providing context to a player's spatial distribution. To generate the playing style, machine learning module 224 may receive event data of various games divided into one or more possessions. Each possession may include one or more touches. For each touch, machine learning module 224 may assign a value to that touch that represents one of the 8 categories of touches. Once all the touches are categorized, playing style module 204 may aggregate these values to generate a weighted count for each player. Playing style module 204 may then normalize these values based on a player's contribution to the team's total. As output, playing style module 204 may generate a vector output describing the team's playing structure.

At step 1008, organization computing system 104 may identify the most common paths a player or team takes between two zones on the field. For example, movement chain module 210 may generate one or more possession motifs that break down sequences of player combinations into chains of X-consecutive player possessions (e.g., four consecutive player possessions) from the same chain. Movement chain module 210 may supplement the possession motifs with zone information from templates 232. Movement chain module 210 may then generate a super group of possession between the two zones and identify the most common paths (or clusters) between the two zones using k-means clustering.

At step 1010, organization computing system 104 may identify each player's involvement in a team's process. For example, player chain module 208 may create a context variable based on the labels and possession motifs created by movement chain module 210. For example, to create the context feature, pre-processing module 226 may concatenate the labels created from a possession motif, the super group of movement chains, and the most common paths taken within the super group (e.g., Start Zone 1, End Zone 8, ABCD, Cluster 1). Pre-processing module 226 may identify the player identifier (e.g., player ID) to create a target feature. Pre-processing module 226 may identify the unique target and context labels and encode them as one hot representation. These one-hot representation features may now represent the inputs to neural network 228. Neural network 228 may generate a final feature vector to represent a player's involvement in a team's possession based on the player's involvement in both the movement chains and the motifs.

At step 1012, organization computing system 104 may generate a score corresponding to a player's value when involved in one or more plays (e.g., a danger value). For example, possession value module 212 may use machine learning module 236 to predict the probability of a goal being scored based on events in the movement chains. This information may allow a team to assess if a player is increasing or decreasing a team's chance of scoring. Possession value module 212 may measure the average value a player increases or decreases the team's chances of scoring. This value may then be standardized as a percentile to represent the zones on the pitch a player creates the most danger or generates the most value.

At step 1014, organization computing system 104 may generate a score associated with each player's passing ability. For example, passing/crossing risk module 214 may predict the probability of a player completing a pass or a cross given the play's current context.

At step 1016, organization computing system 104 may determine a shot style of each player. For example, shooting features module 216 may determine the shot style of each player by dividing the pitch into one or more zones and counting how many shots a player has taken from each zone. In some embodiments, shooting features module 216 may take into account whether the shot was taken with the player's right foot, left foot, or head.

At step 1018, organization computing system 104 may identify a role associated with various players. For example. role prediction module 218 may implement GMM 242 to identify one or more roles that could be assigned to each player. To generate the prediction, GMM 242 may receive, as input, a vector of the features generated by each of spatial feature module 202, playing style module 204, player chain module 208, movement chain module 210, possession value module 212, passing/crossing risk module 214, and shooting features module 216 for one or more players. Given this input, GMM 242 may be configured to generate one or more clusters of players. Each cluster may correspond to a unique player role.

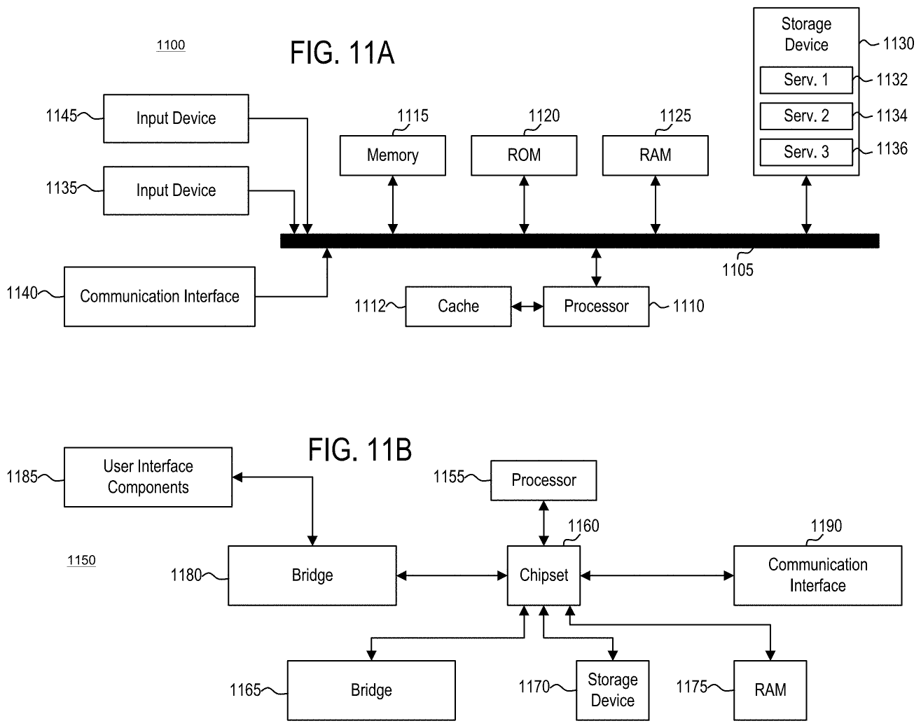

FIG. 11A illustrates an architecture of a computing system 1100 (“system 1100”), according to example embodiments. System 1100 may be representative of at least a portion of organization computing system 104. One or more components of system 1100 may be in electrical communication with each other using a bus 1105. System 1100 may include a processing unit (CPU or processor) 1110 and a system bus 1105 that couples various system components including the system memory 1115, such as read only memory (ROM) 1120 and random access memory (RAM) 1125, to processor 1110. System 1100 may include a cache of high-speed memory connected directly with, in close proximity to, or integrated as part of processor 1110. System 1100 may copy data from memory 1115 and/or storage device 1130 to cache 1112 for quick access by processor 1110. In this way, cache 1112 may provide a performance boost that avoids processor 1110 delays while waiting for data. These and other modules may control or be configured to control processor 1110 to perform various actions. Other system memory 1115 may be available for use as well. Memory 1115 may include multiple different types of memory with different performance characteristics. Processor 1110 may include any general purpose processor and a hardware module or software module, such as service 1 1132, service 2 1134, and service 3 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction with the system 1100, an input device 1145 may represent any number of input mechanisms, such as a microphone for speech, a touch-sensitive screen for gesture or graphical input, keyboard, mouse, motion input, speech and so forth. An output device 1135 (e.g., a display) may also be one or more of a number of output mechanisms known to those of skill in the art. In some instances, multimodal systems may enable a user to provide multiple types of input to communicate with system 1100. Communications interface 1140 may generally govern and manage the user input and system output. There is no restriction on operating on any particular hardware arrangement and therefore the basic features here may easily be substituted for improved hardware or firmware arrangements as they are developed.

Storage device 1130 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1125, read only memory (ROM) 1120, and hybrids thereof.

Storage device 1130 may include services 1132, 1134, and 1136 for controlling the processor 1110. Other hardware or software modules are contemplated. Storage device 1130 may be connected to system bus 1105. In one aspect, a hardware module that performs a particular function may include the software component stored in a computer-readable medium in connection with the necessary hardware components, such as processor 1110, bus 1105, output device 1135, and so forth, to carry out the function.

FIG. 11B illustrates a computer system 1150 having a chipset architecture that may represent at least a portion of organization computing system 104. Computer system 1150 may be an example of computer hardware, software, and firmware that may be used to implement the disclosed technology. System 1150 may include a processor 1155, representative of any number of physically and/or logically distinct resources capable of executing software, firmware, and hardware configured to perform identified computations. Processor 1155 may communicate with a chipset 1160 that may control input to and output from processor 1155. In this example, chipset 1160 outputs information to output 1165, such as a display, and may read and write information to storage 1170, which may include magnetic media, and solid state media, for example. Chipset 1160 may also read data from and write data to storage 1175 (e.g., RAM). A bridge 1180 for interfacing with a variety of user interface components 1185 may be provided for interfacing with chipset 1160. Such user interface components 1185 may include a keyboard, a microphone, touch detection and processing circuitry, a pointing device, such as a mouse, and so on. In general, inputs to system 1150 may come from any of a variety of sources, machine generated and/or human generated.

Chipset 1160 may also interface with one or more communication interfaces 1190 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1155 analyzing data stored in storage 1170 or 1175. Further, the machine may receive inputs from a user through user interface components 1185 and execute appropriate functions, such as browsing functions by interpreting these inputs using processor 1155.

It may be appreciated that example systems 1100 and 1150 may have more than one processor 1110 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method for generating a role summary associated with one or more players, comprising:
retrieving, by a computing system, event information for a plurality of teams for a plurality of events, the event information comprising information associated with a movement of a ball during each event;
generating, by the computing system, a spatial output that describes each player of the one or more players based on the event information;
identifying, by the computing system, a playing style associated with each team of the plurality of teams based on the event information;
identifying, by the computing system, a subset of paths a player or team takes between two zones on a field based on the event information;
identifying, by the computing system, each player's involvement in a team's process based on the event information and the subset of paths the player or team takes between the two zones on the field;
generating, by the computing system, a first score corresponding to a value of a player's involvement in a given play based on the event information;
generating, by the computing system, a second score associated with each player's passing ability based on the event information;
determining, by the computing system, a shot style of each player based on the event information; and
identifying a role associated with each player based on the spatial output, the playing style, the subset of paths, each player's involvement in their team's process, the score corresponding to the value of the player's involvement in a given play, the score associated with each player's passing ability, and the shot style of each player.

2. The method of claim 1, wherein generating, by the computing system, the spatial output that describes each player of the one or more players based on the event information comprising:
identify, by a spatial feature module of the computing system, coordinate data of each player of the one or more players from the event information; and
generate, by the spatial feature module of the computing system, a heat map illustrating a pass origin and pass destination for each pass initiated by each player of the one or more players.

3. The method of claim 2, further comprising:
generate, by the spatial feature module of the computing system, as output, a plurality of factors that describe a spatial distribution of each player of the one or more players.

4. The method of claim 1, wherein identifying, by the computing system, the playing style associated with each team of the plurality of teams based on the event information comprises:
identifying, by a playing style module of the computing system, each event of the plurality of events in the event information; and
for each event, portioning, by the playing style module of the computing system, the event into a plurality of possessions, wherein each possession comprises one or more touches of the ball.

5. The method of claim 4, further comprising:
assigning, by a machine learning module associated with the playing style module, a value to each touch of the one or more touches, wherein the value represents a type of touch;
aggregating, by the playing style module, each value to generate a weighted count for each player of the one or more players; and
generating, by the playing style module, a vector output describing a team's playing structure based on the weighted count for each player of the one or more players associated with the team.

6. The method of claim 1, wherein identifying, by the computing system, the subset of paths the player or team takes between the two zones on the field based on the event information comprises:
generating, by a movement chain module of the computing system, one or more possession motifs, each possession motif configured to break down sequences of player combinations into chains of consecutive player possessions.

7. The method of claim 6, wherein identifying, by the computing system, each player's involvement in the team's process based on the event information and the subset of paths the player or the team takes between the two zones on the field, comprises:
generating, by a machine learning module associated with a player chain module of the computing system, a feature vector representing each player's involvement in the team's possession based on the chains of consecutive player possessions and the one or more possession motifs.

8. The method of claim 7, wherein generating, by the computing system, the first score corresponding to the value of the player's involvement in the given play based on the event information comprises:
predicting, via a machine learning module associated with a possession value module of the computing system, a probability of a goal being scored based on the chains of consecutive player possessions.

9. The method of claim 1, wherein identifying the role associated with each player comprises:
generating, by a gaussian mixture module associated with a role prediction module of the computing system, one or more clusters of players, wherein each cluster corresponds to a unique player role.

10. A non-transitory computer readable medium comprising one or more sequences of instructions, which, when executed by one or more processors, causes a computing system to perform operations comprising:
retrieving, by the computing system, event information for a plurality of teams for a plurality of events, each team comprising one or more players, the event information comprising information associated with a movement of a ball during each event;
generating, by the computing system, a spatial output that describes each player of the one or more players based on the event information;
identifying, by the computing system, a playing style associated with each team of the plurality of teams based on the event information;
identifying, by the computing system, a subset of paths a player or team takes between two zones on a field based on the event information;
identifying, by the computing system, each player's involvement in a team's process based on the event information and the subset of paths the player or team takes between the two zones on the field;
generating, by the computing system, a first score corresponding to a value of a player's involvement in a given play based on the event information;
generating, by the computing system, a second score associated with each player's passing ability based on the event information;
determining, by the computing system, a shot style of each player based on the event information; and
identifying a role associated with each player based on the spatial output, the playing style, the subset of paths, each player's involvement in their team's process, the score corresponding to the value of the player's involvement in the given play, the score associated with each player's passing ability, and the shot style of each player.

11. The non-transitory computer readable medium of claim 10, wherein generating, by the computing system, the spatial output that describes each player of the one or more players based on the event information comprising:
identify, by a spatial feature module of the computing system, coordinate data of each player of the one or more players from the event information; and
generate, by the spatial feature module of the computing system, a heat map illustrating a pass origin and pass destination for each pass initiated by each player of the one or more players.

12. The non-transitory computer readable medium of claim 11, further comprising:
generate, by the spatial feature module of the computing system, as output, a plurality of factors that describe a spatial distribution of each player of the one or more players.

13. The non-transitory computer readable medium of claim 10, wherein identifying, by the computing system, the playing style associated with each team of the plurality of teams based on the event information comprises:
identifying, by a playing style module of the computing system, each event of the plurality of events in the event information; and
for each event, portioning, by the playing style module of the computing system, the event into a plurality of possessions, wherein each possession comprises one or more touches of the ball.

14. The non-transitory computer readable medium of claim 13, further comprising:
assigning, by a machine learning module associated with the playing style module, a value to each touch of the one or more touches, wherein the value represents a type of touch;
aggregating, by the playing style module, each value to generate a weighted count for each player of the one or more players; and
generating, by the playing style module, a vector output describing a team's playing structure based on the weighted count for each player of the one or more players associated with the team.

15. The non-transitory computer readable medium of claim 10, wherein identifying, by the computing system, the subset of paths a player or the team takes between the two zones on the field based on the event information comprises:
generating, by a movement chain module of the computing system, one or more possession motifs, each possession motif configured to break down sequences of player combinations into chains of consecutive player possessions.

16. The non-transitory computer readable medium of claim 15, wherein identifying, by the computing system, each player's involvement in the team's process based on the event information and the subset of paths the player or team takes between the two zones on the field, comprises:
generating, by a first machine learning module associated with a player chain module of the computing system, a feature vector representing each player's involvement in the team's possession based on the chains of consecutive player possessions and the one or more possession motifs.

17. The non-transitory computer readable medium of claim 16, wherein generating, by the computing system, the first score corresponding to the value of the player's involvement in the given play based on the event information comprises:
predicting, via a second machine learning module associated with a possession value module of the computing system, a probability of a goal being scored based on the chains of consecutive player possessions.

18. The non-transitory computer readable medium of claim 10, wherein identifying the role associated with each player comprises:
generating, by a gaussian mixture module associated with a role prediction module of the computing system, one or more clusters of players, wherein each cluster corresponds to a unique player role.

19. A system, comprising:
one or more processors; and
a memory having programming instructions stored thereon, which, when executed by the one or more processors, causes the system to perform operations, comprising:
retrieving event information for a plurality of teams for a plurality of events, each team comprising one or more players, the event information comprising information associated with a movement of a ball during each event;
generating a spatial output that describes each player of the one or more players based on the event information;
identifying a playing style associated with each team of the plurality of teams based on the event information;
identifying a subset of paths a player or team takes between two zones on a field based on the event information;
identifying each player's involvement in a team's process based on the event information and the subset of paths the player or team takes between the two zones on the field;
generating a score corresponding to a value of a player's involvement in a given play based on the event information;
generating a score associated with each player's passing ability based on the event information;
determining a shot style of each player based on the event information; and
identifying a role associated with each player based on the spatial output, the playing style, the subset of paths, each player's involvement in their team's process, the score corresponding to the value of the player's involvement in the given play, the score associated with each player's passing ability, and the shot style of each player.

20. The system of claim 19, wherein generating the spatial output that describes each player of the one or more players based on the event information comprising:
identify, by a spatial feature module, coordinate data of each player of the one or more players from the event information; and
generate, by the spatial feature module, a heat map illustrating a pass origin and pass destination for each pass initiated by each player of the one or more players.
